(19) United States
(12) Patent Application Publication
(10) Pub. No.: US 2011/0155549 A1
(43) Pub. Date: Jun. 30, 2011

(54) Pushbutton

(75) Inventors: Godert De Jager, Zurich (CH); David Haller, Fluringen (CH)

(73) Assignee: EAO HOLDING AG, Olten (CH)

(21) Appl. No.: 12/937,851

(22) PCT Filed: Apr. 14, 2009
(86) PCT No.: PCT/EP2009/054392

§ 371 Date: Dec. 14, 2010

(30) Foreign Application Priority Data
Apr. 14, 2008 (EP) 08154457.9

(51) Int. Cl. H01H 13/14

(52) U.S. Cl. 200/341

(57) ABSTRACT

A pushbutton comprises a cap, a housing with an interior space, a reset element for connecting the cap to the housing, and an electrical switch element. The cap is able to move from a rest position to a switch position relative to the electrical switch element so that the electric switch element, which is disposed inside the housing, can be actuated. The reset element returns the cap to the rest position after actuation. The reset element comprises a first spring means and a second spring means, wherein the first spring means is offset relative to the second spring means at least in the direction of the actuation axis of the cap.

### TECHNICAL FIELD OF THE INVENTION

The present invention relates to a pushbutton according to the features of the precharacterizing clause of claim 1.

### PRIOR ART

Pushbuttons are known as electrical components from the prior art. Pushbuttons normally have a push cap via which the user can apply a force to an electrical switching element by hand. This force operates the electrical switching element. The push cap is in this case normally mounted such that it can be moved in a housing. Furthermore, known pushbuttons have spring means which reset the push cap to the rest position after it has been operated.

By way of example, pushbuttons exist in which the push cap is guided and borne via a sliding guide. In order to achieve optimum, and in particular parallel, movement of the push cap, the push cap has to be guided very precisely in the housing. A parallel movement means a movement along an operating axis, with the push cap being located substantially at right angles to this operating axis. In the case of plastic pushbuttons, this requires a high degree of accuracy of the individual parts as well as a relatively long guide line. The latter in particular leads to pushbuttons with a large physical height.

Furthermore, pushbuttons are known to those skilled in the art in which the push cap is borne via a tilting system or a joint system.

DE 34 29 914 likewise discloses a joint system. DE 34 29 914 discloses a pushbutton with a contact part which is in the form of a leaf spring and with an operating element which acts on the leaf spring. In this case, the leaf spring is used to make an electrical contact.

One disadvantage with the pushbuttons from the prior art is the fact that the switching movement is dependent on the axial position where the force is applied to the pushbutton. This means that the push cap carries out an uncontrolled movement, which is not parallel. This situation is additionally further exacerbated in the case of large-area pushbuttons, as are used by way of example in public transport.

### DESCRIPTION OF THE INVENTION

Against the background of this prior art, the invention is based on the object of specifying a pushbutton which overcomes the disadvantages of the prior art. A further aim is for the push cap of the pushbutton to carry out a substantially parallel movement. A further aim is to provide a pushbutton with a smaller physical height, in which the pushbutton is intended to be operable at least with a short travel. A further aim is for the pushbutton to be vandal-proof.

This object is achieved by a pushbutton having the features of patent claim 1. According to patent claim 1, a pushbutton comprises a push cap, a housing with an internal area, a resetting element which connects the push cap to the housing, and an electrical switching element. The push cap can be moved from a rest position to a switching position relative to the electrical switching element such that the electrical switching element, which is arranged in the internal area of the housing, can be operated. The resetting element resets the push cap to the rest position after operation. The resetting element comprises a first spring means and a second spring means, wherein the first spring means is arranged offset from the second spring means, at least in the direction of the operating axis of the push cap.

The offset arrangement of two spring means results in the advantage that a force applied to any point on the push cap always results in the same parallel movement of the push cap.

The spring means are preferably connected to parts of the push cap or are connected to a push cap support. The push cap support may be an element which is integrally formed on the push cap, or a separate element.

The first spring means is preferably arranged substantially parallel to the second spring means. This further improves the parallelity of the movement of the push cap.

The first spring means and the second spring means are preferably arranged at the same radial distance from the center axis of the push cap. Seen in the direction of the operating axis or the center axis, the first spring means is preferably coincident with the second spring means. Good results were likewise achieved in prototypes with an arrangement offset at an angle.

At least three spring means pairs are preferably provided, each having a first spring means and a second spring means. In this case, the push cap is held centered in the housing.

The first spring means and/or the second spring means are/is preferably in the form of leaf springs or a leaf spring.

The first spring means and/or the second spring means are/is preferably in the form of spring washers or a spring washer, or spring washer segments or a spring washer segment.

The first spring means is preferably arranged at a greater or at a lesser radial distance from the center axis of the push cap than the second spring means.

Further advantageous embodiments are characterized in the dependent claims.

### BRIEF DESCRIPTION OF THE DRAWING

Preferred embodiments will be described in more detail in the following text by way of example with reference to the drawing, in which:

FIGS. 1a, b, c show a schematic sectional view from above (FIG. 1a along the line B-B), from the side in the rest state (FIG. 1b) and in the switching state (FIG. 1c) of a first embodiment of a pushbutton according to the present invention;

FIGS. 2a, b, c show a schematic sectional view from above (FIG. 2a along the line B-B), and from the side in the rest state (FIG. 2b) and in the switching state (FIG. 2c) of a second embodiment of a pushbutton according to the present invention;

FIGS. 2d, e show a schematic sectional view from above (FIG. 2a along the line B-B), and from the side in the rest state (FIG. 2b) according to a further embodiment with a different spring arrangement;

FIGS. 3a, b, c show a schematic sectional view from above (FIG. 3a along the line B-B) and from the side in the rest state (FIG. 3b) and in the switching state (FIG. 3c) of a third embodiment of a pushbutton according to the present invention;

FIG. 4 shows a perspective sectional view of a fourth embodiment;

FIG. 5 shows a sectional view of a fifth embodiment;

FIGS. 6a, b show sectional views of a sixth embodiment;

FIG. 7a shows a plan view of a seventh embodiment; and

FIG. 7b shows a perspective view of the seventh embodiment.

### DESCRIPTION OF PREFERRED EXEMPLARY EMBODIMENTS

Possible exemplary embodiments will be described with reference to the drawings. The drawings and the description show and describe preferred exemplary embodiments and should not be interpreted in order to restrict the invention which is defined by the claims.

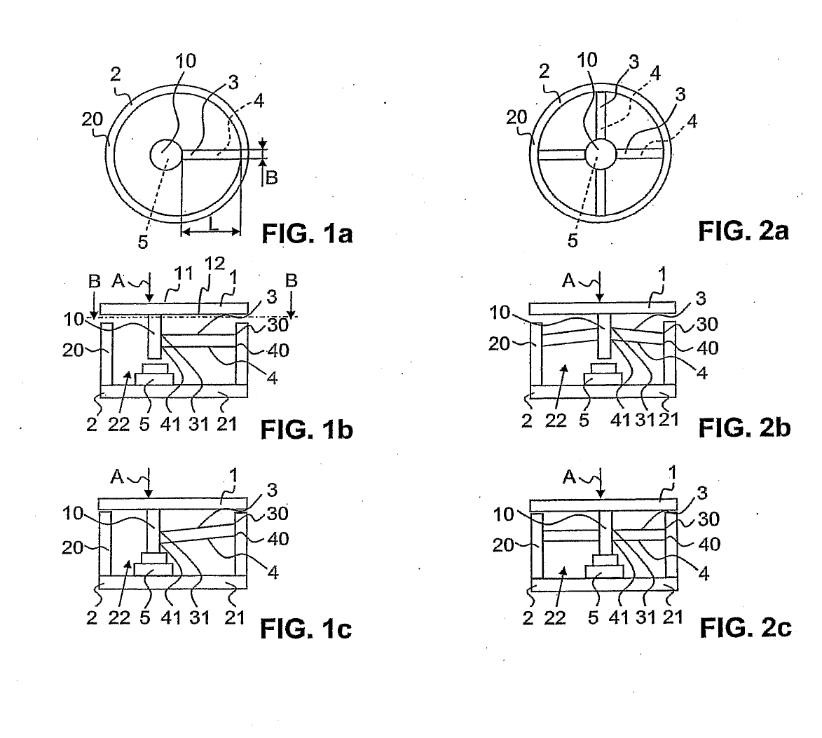

FIGS. 1a-1c show outline sketches of a pushbutton according to the present invention. The pushbutton illustrated here comprises a push cap 1, a housing 2, resetting elements 3, 4 and an electrical switching element 5. A user can operate the electrical switching element 5 via the push cap 1. The pushbutton according to the invention may be used, for example, in public transport. In this case, the passenger operates the pushbutton in order, for example, to open the doors of a train, of a bus or of a tram. In this case, the electrical switching element 5 is electrically connected to the door control system and closes an electrical circuit, as a result of which the door drives are operated.

The user moves the push cap 1 from a rest position (see FIG. 1b) along an operating direction or operating axis A to a switching position (see FIG. 1c). The operating direction A is in this case directed at right angles to the push cap 10. In the rest position, the push cap 1 is positioned with respect to the electrical switching element 5 such that the latter is not operated. FIG. 1b shows the push cap 1 in the rest position. FIG. 1c shows the switching position, showing that parts of the push cap 1 rest on the electrical switching element 5, have moved parts of the electrical switching element 5, and have accordingly operated it.

In this case, the push cap 1 has an upper face 11 and a lower face 12, on which a push cap support 10 is integrally formed. The push cap support projects substantially at right angles from the push cap 1. The electrical switching element 5 is operated by this push cap support 10.

In this case, the push cap 1 is connected via the resetting elements 3, 4 to the housing 2. In the present exemplary embodiment, the housing 2 is substantially circular-cylindrical and has a side wall 20 which extends at right angles from a rear wall 21. Other outline shapes, for example an oval, a rectangle, a square or a polygon, are likewise feasible.

Because of the resetting elements 3, 4, the push cap 1 returns from the switching position to the rest position as soon as the user no longer operates the push cap 1.

In the present first exemplary embodiment, the resetting elements 3, 4 consist of a first spring means 3 and a second spring means 4. The two spring means 3, are in this case in the form of leaf springs. Expressed in a general form, the two spring means 3, 4 may also be referred to as spring means pairs, since they are arranged in pairs.

Seen in the operating direction A, the two spring means 3, 4 are arranged one above the other, and in this case in particular coincident with one another. Furthermore, the spring means 3, 4 are arranged offset, or at a distance from one another, in the operating direction A. In this case, the spring means 3, 4 are firmly connected at a first outer end 30, 40 to the housing 2, in this case to a side wall 20. The spring means 3, 4 could also be connected to another housing part. At a second end 31, 41, the spring means 3, 4 are firmly connected to the push cap 1 or to parts of the push cap 1, for example in this case to the push cap support 10. The leaf springs 3, 4 are therefore clamped in firmly at both ends. Seen in a direction at right angles to the operating direction A, it can also be said that the spring means 3, 4, together with the parts of the pushbutton 1 and of the housing 2, form a parallelogram. This is accordingly a solid joint. The firmly clamped-in springs 3, 4 are used not only for resetting but also for driving the push cap 1 in the housing 2 since the two outer ends 30, 40 move substantially virtually parallel to the operating direction A, because they are clamped in firmly. To this extent, it is not important that the push cap support 10 is aligned at right angles to the operating direction A, and the important factor is that the spring means 3, 4 are attached in such a way that they are arranged offset from one another in the operating direction A. The location of the arrangement of the push cap support 10 can also be chosen freely, and for example it is feasible to arrange the push cap support 10 such that it is located in the center of the housing 2, or such that, as is illustrated in FIG. 1a, it is arranged offset from the center of the housing 2.

In other words, it can also be said that the arrangement of the spring means 3, 4 during operation of the push cap 1 along the operating direction A results in uniform s-shaped deformation of the first spring means 3 and of the second spring means 4. This in turn leads to a virtually linear movement of the push cap 1 along the operating direction A.

The firm clamping in and the parallel arrangement furthermore result in the advantage that, when force is applied to any point on the push cap 1, that always results in the same parallel movement of the push cap 1. The electrical switching element 5 can accordingly be placed at any desired position under the push cap, and defined switching movements can be maintained within a narrow tolerance range despite the different placing. Furthermore, the spring elements guide the push cap 1, as a result of which there is no need for a guide between the housing and the push cap. There is accordingly no friction between the housing and the push cap. There is likewise no play adversely affecting the switching sensation. A small slot opening can be provided between the push cap 1 and the housing 2 as a result of the uniform movement of the push cap 1 with respect to the housing 2 and the small physical height. This makes it harder for vandals to insert sharp-edged and thin objects, such as the blade of a knife, thus improving the protection against vandals.

In the rest position, the leaf springs 3, 4 are arranged substantially at right angles to the operating direction A. This can be seen in FIG. 1b. In the switching position, the major parts of the leaf springs 3, 4 are at an angle to the operating direction A. Alternatively, the leaf springs 3, 4 can also be at an angle to the operating direction A when in the rest position. In this case, the leaf springs 3, 4 can be directed both against the push cap 1 and against the rear wall 21.

In this case, the leaf springs have a length L which is greater than the radius of the housing 2. The push cap support 10 is therefore located eccentrically with respect to the housing 2. Leaf springs with a great length L have the advantage that the operating force is less, while the operating movement distance of the push cap 1 remains the same. However, it is also possible to choose the length L of the leaf springs 3, 4 such that they correspond substantially to the radius of the housing 2, as a result of which the push cap support comes to rest concentrically with respect to the housing 2. In some applications, it may likewise be advantageous to choose the length to be shorter than the radius.

In the case of a push switch with a push cap diameter of 50 mm, the corresponding leaf springs have, for example, a length L of 35 mm and a thickness of 0.2 mm. These dimensions can result in a switching movement of 1 mm. The tolerance range for undefined operation is in this case in the region of ±0.1 mm. Other dimensions and switching movements are likewise feasible.

By way of example, the spring means 3, 4 shown here may be composed of a metallic material, in particular of a spring steel. Alternatively, the spring means 3, 4 may also be composed of a plastic, for example of a fiber-reinforced plastic or an elastomer. It is also feasible to combine said materials. For example, it is feasible to sheath the metallic material with the elastomer. For example, the spring means 3, 4 can be inserted into slots which are arranged in the push cap 1 and/or in the housing 2, and can be secured, for example, with an adhesive. Alternatively, the spring means 3, 4 can be connected by means of an adhesive to the push cap 1 or to the housing 2. If the push cap 1 and the housing 2 are composed of plastic, it is also feasible for the spring means 3, 4 to be connected directly to the push cap 1 and to the housing 2 during the injection-molding process.

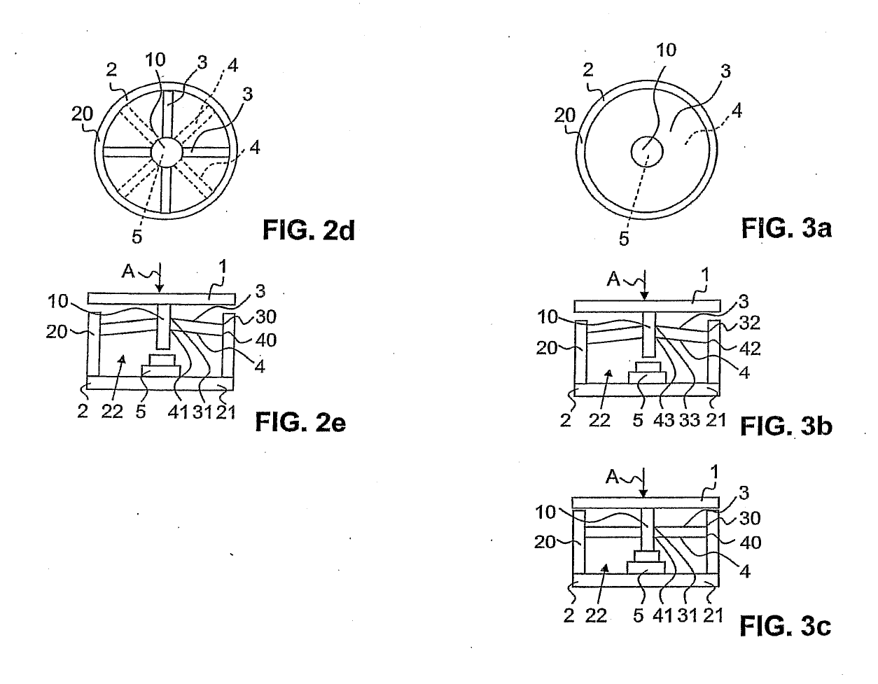

FIGS. 2a-2c show a second embodiment of a pushbutton. The same parts are provided with the same reference symbols. A plurality of spring means pairs 3, 4 are arranged in this embodiment. The spring means pairs 3, 4 are in this case once again in the form of leaf springs. At least three spring means pairs 3, 4 are preferably arranged distributed at uniform intervals around the circumference of the housing 2. In the case of a cylindrical housing, a uniform interval means the same angle between a first spring means pair 3, 4 and a second spring means pair 3, 4. If there are three spring means pairs 3, 4, the angle between two adjacent spring means pairs 3, 4 is accordingly 120°. The arrangement of at least three spring means pairs has the advantage that the push cap 1 is moved parallel to the operating direction A and centered with respect to the side wall 20 of the housing 2.

In the present embodiment, four spring means pairs 3, 4 are shown, and are each arranged with an angle of 90° between them.

Alternatively, two spring means pairs 3, 4 can also be arranged, in which case the spring means pairs must have a greater stiffness in respect of a possible linear movement at right angles to the operating direction A, thus making it possible to prevent the push cap from being sheared off laterally. For example, in this case, it is feasible for the spring means pairs to have a greater width B.

In one alternative embodiment as shown in FIGS. 2d and 2e, the first spring means 3 are arranged offset axially and at an angle from the second spring means 4, which are in this case shown by dashed lines. In this case, the second spring means 4 are at a distance from the first spring means 3 in the direction of the operating axis A or center axis, as has already been described above. Furthermore, the second spring means 4 are arranged at an angle to the first spring means 3, when seen from above. In the present embodiment, the offset angle is 45°. This configuration also allowed good results to be achieved in respect of the parallelity of the movement of the push cap 1 during operation.

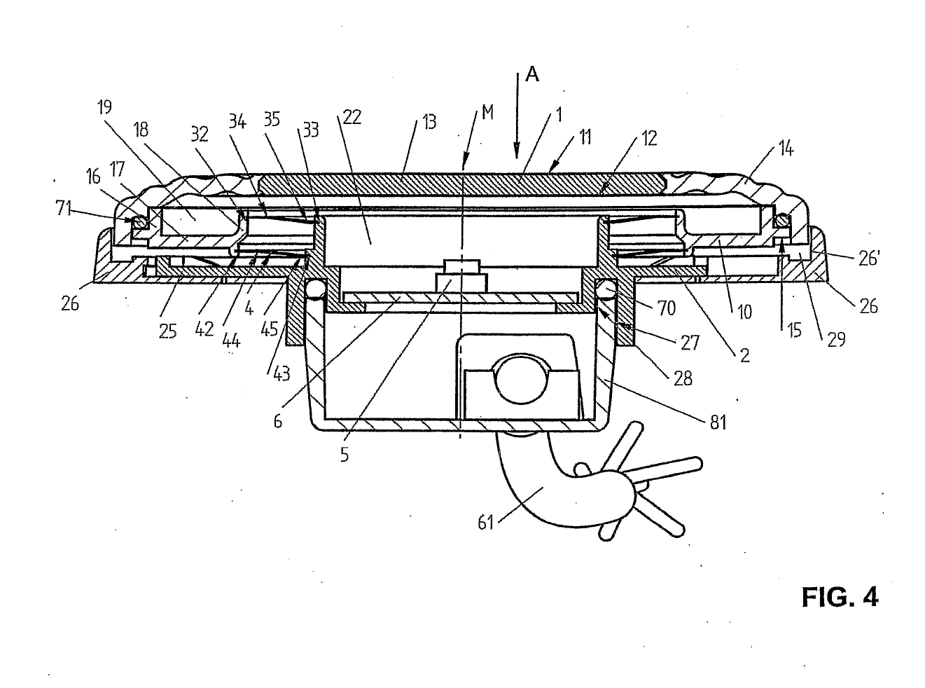

FIGS. 3a-3c show a third embodiment of a pushbutton. The same parts are once again provided with the same reference symbols. In this case, the spring means 3, 4 are in the form of spring washers. In this case, two physically identical spring washers are arranged parallel to one another.

The spring washers 3, 4 have an outer circumference 32, 42 and an opening 33, 43 which runs concentrically with respect to this circumference and extends through the spring washer. Seen in the direction of the center axis, the outer circumference 32, 42 and the opening 33, 43 are axially offset with respect to one another, thus resulting in a spring washer 3, 4 with a conical profile. A flat spring washer 3, 4 can alternatively also be used.

In the installed state, the push cap support 10 is firmly connected to the opening 33, 43, while the side wall 20 of the housing 2 is firmly connected to the outer circumference 32, 42. When the push cap is operated, the two spring washers 3, 4 act analogously to the leaf springs described above.

The arrangement of the spring washers 3, 4 in pairs has the advantage that this once again results in a movement which is substantially parallel to the operating direction A. Furthermore, the spring washers 3, 4 act as sealing elements, which seal the internal area 22, in which the electrical switching element 5 is arranged, from the push cap 1. In this case, the internal area 22 is sealed against environmental influences, such as water, dust or the like. Large-area spring elements 3, 4 can also be provided for this purpose. In this case, in particular, it is feasible for the spring element 4 which is arranged closer to the electrical switching element to be solid, while the other spring element 3 is in the form of a spring washer.

Alternatively, for example, it is also feasible to use spring washer segments arranged in pairs. A spring washer segment means a circle segment of a spring washer as described above. In this case, a circle segment such as this extends, for example, over an angle of 20° to 90°. The spring washer segments are arranged at regular intervals, analogously to the leaf springs described with the second exemplary embodiment above.

The arrangement of spring means described herein makes it possible to provide a pushbutton with a considerably smaller installation depth while, at the same time, the diameter of the operating surface can be enlarged for the same operating force and the same operating movement. The defined and parallel movement of the push cap and the increase in the diameter result in greater flexibility in placing of the electrical switching elements, which are not arranged directly under the push cap support 10. Furthermore, a plurality of switching elements can be arranged in one pushbutton.

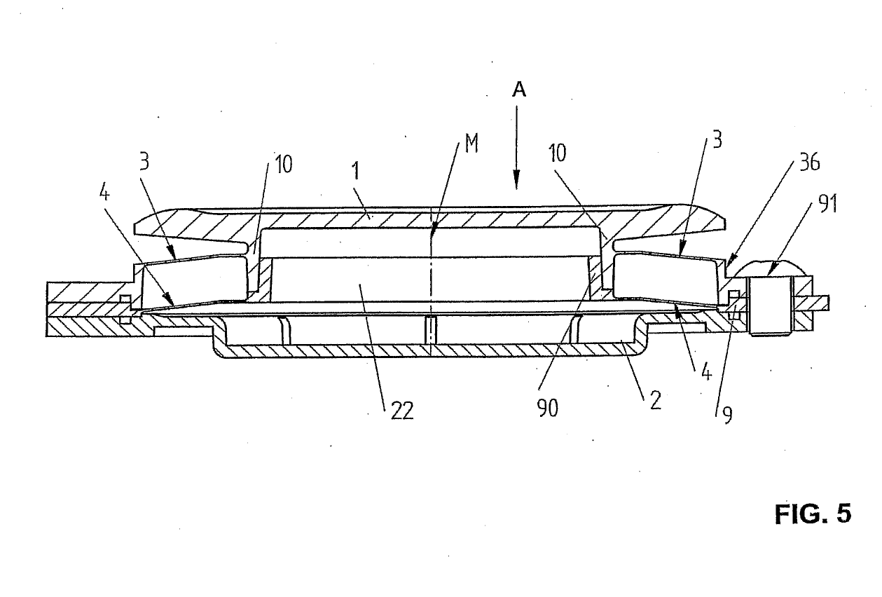

FIG. 4 shows a sectioned perspective view of a fourth exemplary embodiment. Once again, the same parts are provided with the same reference symbols.

In this case, the push cap 1 has a fixed, preferably circular, center part 13 which is completely surrounded by a cap element 14, which in this case is in the form of an annular element 14. The center part 13 is substantially in the form of a flat disk. The cap element 14 has in this case a corrugated structure and extends away from the center part 13 in the radial and axial directions until, finally, it merges into a rim 15. The rim 15 extends in the axial direction substantially at right angles to the upper face 11 of the center part 13. The cap element 14 may also be referred to as a flexible ring.

The cap element 14 is furthermore connected to the push cap support 10, which in this case is substantially annular. In this case, the push cap support 10 has an outer ring 16 oriented axially, from which a flange 17 extends in the radial direction. A flange 17 opens in an inner ring 18, which is likewise oriented in the axial direction. The outer ring 16, the flange 17 and the inner ring 18 in this case bound a circumferential annular channel 19. By way of example, the annular channel 19 can be used to accommodate electrical components, such as a printed circuit board with light-emitting diodes or an annular LCD display. In this case, for example, the cap element 14 may be composed of a transparent or light-transmissive material. The light-emitting diodes can then be seen from the outside by the user.

The outer ring 16 has a somewhat smaller diameter than the rim 15, thus creating an intermediate space between the outer ring 16 and the rim 15. In the present embodiment, a sealing element 71, in this case an O-ring, is arranged in this intermediate space. The sealing element 71 is used to seal the annular channel 19 from environmental influences. Furthermore, the internal area 22 is in this case sealed by the two spring means 3, 4. For example, if moisture or dust were to enter the area between the rim 15 and the rim 26′ of the guide element 26, it cannot penetrate into the internal area 22, because of the spring arrangement. There are a multiplicity of connection options for connecting the push cap 1 to the push cap support 10: snap-action connection, welded joint (ultrasound welding), screw connection, riveted joint, adhesive joint, etc.

The inner ring 18 of the push cap support 10 is connected to the two spring means 3, 4. In this case, the spring means 3, 4 are once again in the form of spring washers. In this case, the spring washers 3, 4 extend'from the inner ring 18 inward in the radial direction, that is to say toward the center axis M of the pushbutton. The spring washers 3, 4 are connected to the housing 2 by the edge of their opening 33, 43.

In this case, the spring washers 3, 4 have two optional circumferential bend points 34, 44 and 35, 45, which can also be referred to as a bead. The bend points 33, 44 and 35, 45 divide the spring washers into three radial sections. The bend points 34, 44 and 35, 45 have the advantage that a clicking noise can be produced when they snap over. This means that, when the user operates the pushbutton, he receives mechanical feedback in the form of a clicking noise.

Together with a side wall 20, the housing 2 in this case once again forms an internal area 22. In this embodiment, the internal area 22 is used to accommodate a printed circuit board 6 on which the electrical switching element 5 is arranged. In this case, the printed circuit board 6 rests on a flange 24 which extends from the side wall 20 into the internal area 22. In this case, the flange 24 and the printed circuit board 6 form the bottom 21 of the housing 2. Furthermore, the housing 2 has a further flange 25 which extends outward from the side wall 20 in the radial direction. A guide element 26 is integrally formed on the flange 25 and is used for guiding the cap element 14 and, in the end, the push cap 10. Furthermore, the flange 25 and the guide element 26 act as attachment elements, in order to attach the pushbutton to a flat element, for example a door. The lower edge 15′ of the rim 15 in this embodiment rests on the guide element 26 in the switching state. The guide element has an annular gap 29 in order to accommodate the rim 15.

In this case, in the area of the junction between the side wall 21 and the flange 25, the housing 2 has a further side wall 27 which extends substantially at right angles from the flange 25. In this case, an annular gap 28 is formed in the lower area of the housing, between the side wall 21 and the further side wall 27, and is used to accommodate a sealing means 7, in this case an O-ring 70, and a rim 81 of a shell 8. In this embodiment, the cable 61 is passed via the shell 8 to the printed circuit board 6.

In one alternative embodiment, which is not shown here, essentially two push cap supports are provided. A first push cap support is substantially in the form of the annular push cap support 10 as described above. This push cap support is in this case connected by a first spring element 3 to the housing 2. A second push cap support is in this case designed analogously to that in the first exemplary embodiment, and can accordingly also be referred to as being in the form of a rod. Accordingly, the second push cap support projects at right angles from the center part 13, and preferably projects through the first spring element 3. In this case, the second spring element 4 is connected to the second push cap support and to the housing 2. In this case, the first spring element 3 is arranged closer to the push cap 1 than is the second spring element 4.

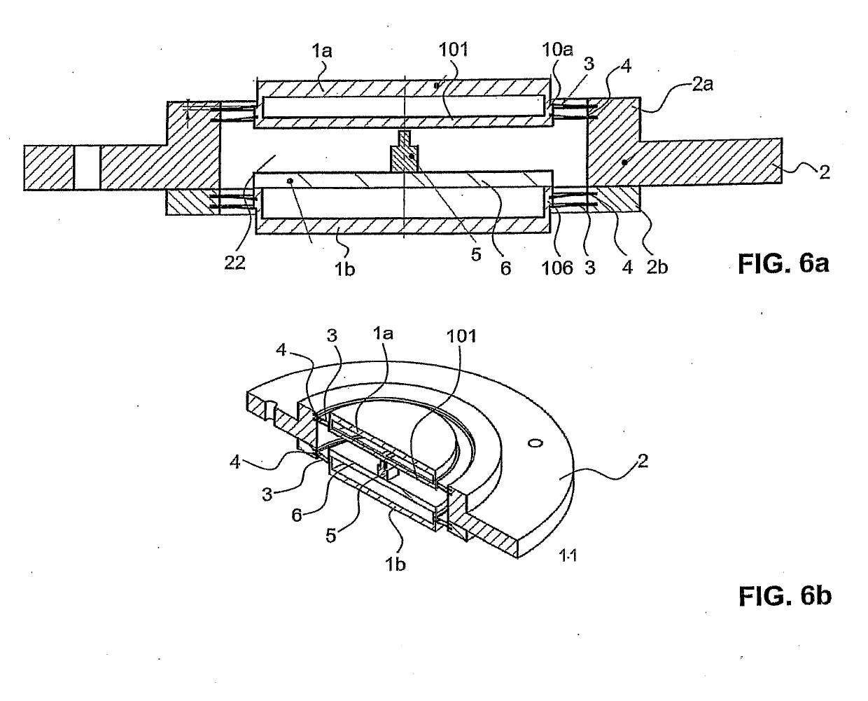

FIG. 5 shows a fifth embodiment of a pushbutton. In this embodiment, the first spring element 3 is an integral component of the push cap 1. In this case, the push cap 1 likewise has a push cap support 10 which is integrally formed on the push cap 1 and projects at right angles from the push cap 1 in the direction of the electrical switching element 5. The push cap support 10 could also be referred to as a side wall. In this case, the spring element 3 projects from this push cap support 10. Furthermore, a circumferential rim 36 is integrally formed on the spring element 3 in this case.

A push cap holding element 9 is in this case arranged between the housing 2 and the push cap 1. The push cap holding element 9 has a circumferential rim 90 which is designed such that it can be connected to the push cap support 10. The second spring element 4 projects from this rim 90 and rests on parts of the housing 2.

In the assembled state, the circumferential rim 90 is connected to the push cap support 10. The circumferential rim 36 of the first spring element 3 in this case rests on the housing 2 and on the push cap holding element 9. The push cap holding element 9 rests on the housing 2 such that the circumferential rim 90 can be moved relative to the housing 2 within the range of the spring effect. As can be seen in the figure, the first spring element 3 and the second spring element 4 are parallel to one another and are arranged at a distance from one another in the direction of the operating axis A. Furthermore, the spring elements 3, 4 extend at an angle outward away from the center axis M of the pushbutton.

Once again, an electrical switching element 5 is in this case arranged in the internal area 22 of the housing 2, and is operated by the movement of the push cap 1.

The push cap 1, the housing 2 and the push cap holding element 9 are preferably connected to one another by attachment means 91, such as screws or rivets.

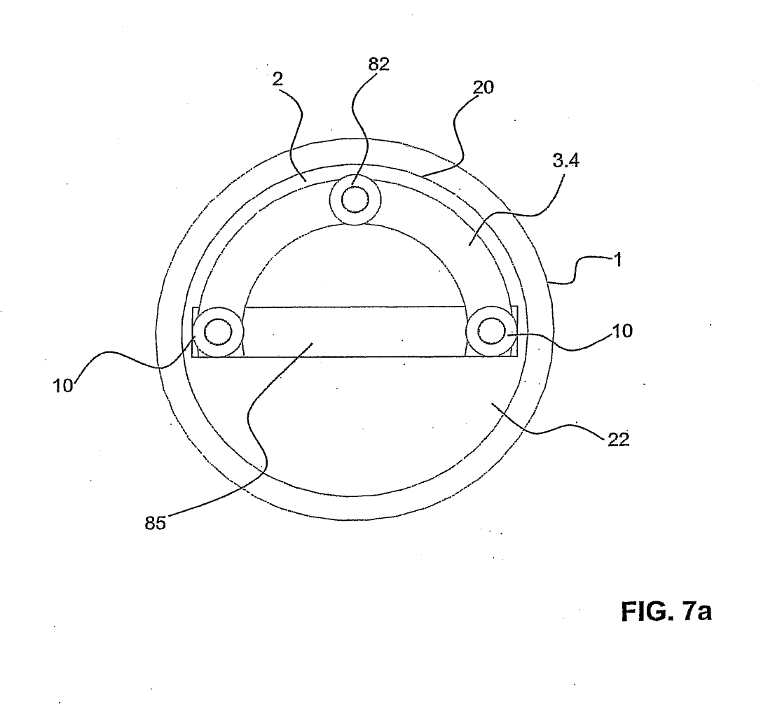

FIGS. 6a and 6b show a sixth embodiment, in which the pushbutton has an upper or first push cap 1a and a lower or second push cap 1b. The two push caps 1a, 1b are arranged parallel to one another. In this embodiment, the respective push cap support 10a or 10b is likewise integrally formed on the lower face of the corresponding push cap 1a, 1b and projects into the internal area 22 in the housing 2. The respective push cap support 10a or 10b is once again connected to the housing 2 via a respective first spring element 3 and a second spring element 4. In this embodiment, the housing 2 consists of an upper part 2a and a lower part 2b, which are connected to one another. The upper push cap 1a is in this case connected to the upper part 2a, and the lower push cap 1b is connected to the lower part 2b.

Furthermore, an operating plate 101 is integrally formed on the push cap support 10a, on the side facing the internal area 22, is moved in the direction of the switching element 5 during operation of the push cap 1a, and then operates the switching element 5.

The second push cap support 10b is in the case connected to the printed circuit board 6, on which the switching element 5 is arranged. In this case, the printed circuit board 6 is arranged such that it is located in the internal area 22. When the push cap 1b is operated, the printed circuit board 6 is moved together with the switching element 5 in the direction of the operating plate 101, and is accordingly operated. In other words, this means that the printed circuit board 6 is mounted in the housing 2 such that it can be moved in the axial direction against the first push cap 1a. The linear movement is in this case initiated by the operation of the second push cap 1b. The linear movement of the printed circuit board 6 at the same time also moves the electrical switching element 5 in the axial direction, and operates it when it makes contact with the first push cap 1a or the operating plate 101. In this embodiment, both push caps 1a, 1b are mounted via the spring elements 3, 4 described above. In this case, the spring elements 3, 4 are likewise used as sealing elements, in order to seal the internal area 22 from the environment.

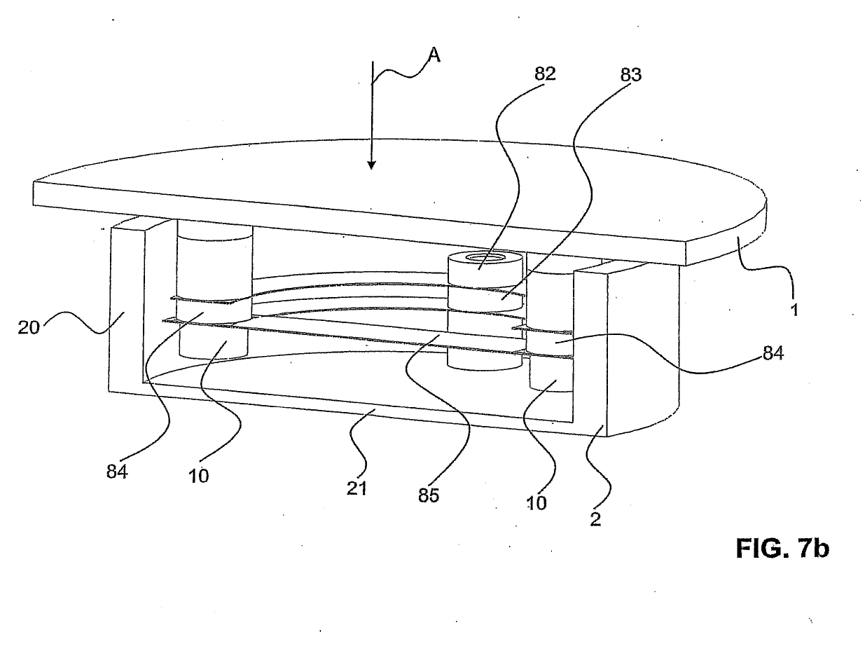

FIGS. 7a and 7b respectively show a plan view and a perspective view of a further embodiment of a pushbutton. In this case, the same parts are provided with the same reference symbols.

The push cap 1 has two push cap supports 10 which are integrally formed on the push cap 1 and project downward from the push cap. The push cap supports are in this case cylindrical and project into the internal area 22 in the housing 2, when, as described, the push cap 1 is connected to the housing 2 via the spring means 3, 4.

In the internal area 22, the housing 2 has a bearing point 82 which in this case projects from the rear wall 21, and is arranged in a fixed position with respect to the internal area 22. The bearing point 82 is in this case substantially cylindrical.

In this case, the first spring means 3 and the second spring means 4 are in the form of spring washer segments which extend over an angle of 180°. In other words, it can also be said that the spring washer segments 3, 4 are in the form of bisected circular rings. Smaller or larger angle segments are likewise feasible. For example, it is feasible for the spring washer segment to extend over an angle in the range from 135° to 225°.

The two spring means 3, 4 are connected to the bearing point 82. The spring means 3, 4 are connected to the bearing point 82 such that the spring means 3, 4 extend substantially uniformly on both sides, seen from the bearing point 82. In other words, this means that the spring means 3, 4 are mounted centrally. The bearing point 82 has an element 83 which ensures a separation between the first spring means 3 and the second spring means 4.

The spring means 3, 4 are connected to the associated push cap support 10 via both ends. The push cap supports 10 likewise each have a spacing element 84, which ensures that the first and the second spring means 3 and 4, respectively, are the same distance apart. In this case, the two spring means 3, 4 are substantially parallel to one another and are substantially at right angles to the center axis of the operating direction of the push cap 1. When the push cap 1 is now operated from above along the operating axis A, then the two spring means 3, 4 bend in the operating direction, because of the movement of the two push cap supports 10. The spring characteristics and the corresponding arrangement of the spring means 3, 4 result in a resetting movement in the opposite direction to the operating direction A, as a result of which the push cap 1 is reset to the original position.

Furthermore, the two push cap supports 10 are connected to one another via a yoke or web 85 in the area of the first spring means 3. The web 85 essentially has the function of preventing linear movement of the two push cap supports 10 away from one another during the operating process, that is to say when a force is applied.

Furthermore, the web 85 may also be in the form of an operating element for an electrical switching element which is arranged in the internal area 22 and is not shown here. Alternatively, an intermediate piece, which is not shown but operates the switching element, can also be integrally formed on the push cap.

The two spring means 3, 4 may be composed of metal as well as a plastic. If the spring means 3, 4 are composed of a metallic material, they can be inserted into the injection-molding tool and are then coated with the plastic. In the embodiment composed of plastic, all the elements can be produced in one mold, thus allowing the mechanical parts of a pushbutton to be formed integrally.

In one alternative embodiment, which is not illustrated, it is also feasible for the spring means 3, 4 to be in the form of a rectangular frame when seen from above.

### LIST OF REFERENCE SYMBOLS

1 Push cap
2 Housing
3 First spring means
4 Second spring means
5 Electrical switching element
6 Printed circuit board
7 Sealing means
8 Shell
9 Push cap holding element
10 Push cap support
11 Upper face
12 Lower face
13 Center part
14 Cap element
15 Rim
16 Outer ring
17 Flange
18 Inner ring
19 Annular channel
20 Side wall
21 Rear wall
22 Internal area
23 Annular element
24 Flange
25 Flange
26 Guide element
27 Side wall
28 Annular gap
29 Gap
30 First end
31 Second end
32 Outer circumference
33 Opening
34 Bend point
35 Bend point
36 Circumferential rim
40 First end
41 Second end
42 Outer circumference
43 Opening
44 Bend point
45 Bend point
61 Cable
70 O-ring
71 O-ring
81 Rim
82 Bearing point
83 Spacing element
84 Spacing element
85 Yoke
90 Circumferential rim
91 Attachment means
101 Operating plate

1-14. (canceled)

15. A pushbutton comprising
a push cap,
a housing with an internal area,
a resetting element which connects the push cap to the housing and which comprises a first spring element and a second spring element, wherein the first spring element is arranged offset from the second spring element, at least in a direction of an operating axis of the push cap, and
an electrical switching element, wherein the push cap can be moved from a rest position to a switching position relative to the electrical switching element such that the electrical switching element, which is arranged in the internal area of the housing, can be operated, wherein the resetting element resets the push cap to the rest position after operation.

16. The pushbutton as claimed in claim 15, wherein the first spring element and the second spring element are connected to a part of the push cap.

17. The pushbutton as claimed in claim 15, wherein the first spring element and the second spring element are connected to a push cap support.

18. The pushbutton as claimed in claim 15, wherein the first spring element is arranged substantially parallel to the second spring element.

19. The pushbutton as claimed in claim 15, wherein the first spring element and the second spring element are arranged at the same radial distance from a center axis of the push cap.

20. The pushbutton as claimed in claim 15, wherein at least three resetting elements are provided, and each of the resetting elements comprises a first spring element and a second spring element.

21. The pushbutton as claimed in claim 15, wherein the first spring element is in the form of a leaf spring.

22. The pushbutton as claimed in claim 15, wherein the second spring element is in the form of a leaf spring.

23. The pushbutton as claimed in claim 15, wherein the first spring element is in the form of a spring washer or a spring washer segment.

24. The pushbutton as claimed in claim 15, wherein the second spring element is in the form of a spring washer or a spring washer segment.

25. The pushbutton as claimed in claim 15, wherein the first spring element is arranged at a greater radial distance from a center axis of the push cap than the second spring element.

26. The pushbutton as claimed in claim 15, wherein the first spring element is arranged at a lesser radial distance from a center axis of the push cap than the second spring element.

27. The pushbutton as claimed in claim 15, wherein the first spring element is integrally formed on the push cap and on the housing, and wherein the second spring element is integrally formed on the push cap and on the housing.

28. The pushbutton as claimed in claim 15, wherein the first spring element is integrally formed on the push cap and on an element, the push cap and the element being arranged in a fixed position relative to the housing, and wherein the second spring element is integrally formed on the push cap and on the element, the push cap and the element being arranged in a fixed position relative to the housing.

29. The pushbutton as claimed in claim 15, wherein the first spring element and the second spring element are composed of a metallic material and can be used as an electrical line.

30. The pushbutton as claimed in claim 15, wherein two push caps are arranged opposite in an operating direction, wherein the electrical switching element is arranged on a plate which is moveable relative to the first push cap such that, when the second push cap is operated, the plate is moved with the electrical switching element against the first push cap, and is therefore operated.

31. The pushbutton as claimed in claim 15, wherein at least two electrical switching elements are arranged and can be operated by one operating process.

32. The pushbutton as claimed in claim 15, wherein the spring elements are composed of plastic, wherein the housing and the push cap over the spring elements are formed substantially integrally.
